(19) United States
(12) Patent Application Publication
(10) Pub. No.: US 2006/0278514 A1
(43) Pub. Date: Dec. 14, 2006

(54) Control lever for a manipulator

(75) Inventor: Xavier Roussin-Bouchard, La Murette (FR)

Correspondence Address: OLIFF & BERRIDGE, PLC, P.O. BOX 19928, ALEXANDRIA, VA, 22320, US

(73) Assignee: BOSCH REXROTH D.S.I., VENISSIEUX (FR)

(21) Appl. No.: 10/570,158

(22) PCT Filed: Oct. 5, 2004
(86) PCT No.: PCT/FR04/02512

§ 371 Date: Mar. 1, 2006

(30) Foreign Application Priority Data
Oct. 14, 2003 (FR) 0311996

(51) Int. Cl. H01H 1/10

(52) U.S. Cl. 200/512

(57) ABSTRACT

A control lever for a manipulator, used in particular for heavy construction machines, comprising a frame defining a cavity, and at least one control button which is actuated by an operator in order to control hydraulic jacks, characterized in that at least one control button comprises at least one lower insulating layer and one upper insulating layer placed on top of each other, whereby a lower conducting layer is fixed to the lower layer, and a second upper conducting layer is arranged opposite the first where the control button is arranged, both elements being separated in the absence of pressure exerted by the finger of the operator and being able to enter into contact when the pressure exerted when the pressure exerted by the finger of the operator is transmitted to the upper layer, whereupon said upper layer becomes deformed and transmits said movement to the upper conducting element, whereupon the contact between the lower conducting elements and upper conducting elements closes an electric circuit generating an electronic control signal.

The present invention relates to a control lever intended in particular for heavy construction machines.

In a heavy construction machine, the operator controls actuators by manipulating a lever. This lever incorporates control buttons which may be of the proportional or “on/off” type. A control button makes it possible for example to control an electrovalve, an electrically operated directional flow valve, an audible warning or a gearbox control.

The lever must have a large number of control buttons in a small space. For example, a control button of the on/off type consists, in a known manner, of one part supporting an electrical contactor and a second mechanical part, mounted pivotingly or movable in translation relative to the first part to press on the contactor under the pressure of the operator's finger, the second part being capable, where necessary, of being linked to return and/or locking means to obtain a return effect and/or a bistable button effect.

This type of button has several disadvantages:
its space requirement limits the number of such buttons that can be housed on the lever,
its positioning is also restricted, the location on the lever not being able to be arbitrary due to the necessary depth,
the sealing of the lever is not assured, because interstices are made between the mechanical parts,
the legibility of the markings made on the button is poor in a dark cabin,
the markings made on the button gradually wear away with repeated use.

In addition, during manufacture, this type of button does not offer a modularity making it possible to easily modify the functions performed by all the buttons on the lever.

The object of the present invention is to solve the technical problems raised hereinabove, particularly for the production of buttons of the “on/off” type.

Consequently, the subject of the present invention is a control lever for a manipulator, intended in particular for heavy construction machines, comprising a frame delimiting a cavity, and at least one control button intended to be actuated by an operator, characterized in that at least one control button consists of at least one lower insulating layer and one upper insulating layer placed on top, a lower conducting element being attached to the lower layer and a second upper conducting element being situated opposite the first in the location of a control button, these two elements being separated in the absence of pressure from the operator's finger and being able to enter into contact when pressure is transmitted from the operator's finger to the upper layer, the upper layer deforming and transmitting this movement to the upper conducting element, the contact between the lower conducting element and upper conducting element closing an electric circuit generating an electric control signal.

Thanks to this arrangement, it is possible to produce control buttons having a minimal space requirement, thus making it possible to position a larger number of them on the lever, and to choose their location with no restriction associated with the depth of the buttons.

According to one possibility, the upper conducting element consists of a convex and deformable conducting cup attached to the lower layer.

According to another possibility, the upper conducting element consists of a conducting track made of a screen-printed conducting ink on the lower face of the upper layer, an intermediate layer being placed between the upper layer and lower layer, this intermediate layer having an opening in the location of the control button and separating the upper conducting element and lower conducting element when there is no pressure on the button.

The alternative arrangements described hereinabove make it possible advantageously to produce conducting elements having a reduced thickness.

Advantageously, an outer layer is attached on top of the upper layer, this layer comprising a serigraph on its inner face.

The production of a serigraph on the inner face of the outer layer makes it possible to carry indications on the button in a manner that cannot be erased by repeated contacts of the operator's fingers on the button.

According to one embodiment, the lower layer comprises at least one light source allowing the backlighting of at least one portion of a control button.

This arrangement allows the operator to see, even in darkness, the indications carried on the buttons and to locate the buttons.

Advantageously, several control buttons are made with the same lower and upper layers.

It is possible to make flexible keypads grouping several buttons together in a compact manner.

According to one embodiment, the number of control buttons made with the same lower and upper layers can be varied according to the shape of the upper conducting elements for one and the same shape of the lower conducting elements.

The production of a flexible keypad, as described, makes it possible to easily modify the number and disposition of the buttons.

Advantageously, the layers forming the control buttons are attached by bonding, thus sealing the buttons.

The buttons, being made by an assembly of bonded layers, have no interstices allowing humidity to pass through.

The present invention also has as its subject a method of manufacturing a lever as described hereinabove, characterized in that the outer layer is deformed in order to form a blister in the location of a control button, this deformation being adjustable according to the operating force required to depress the button.

It is therefore possible to choose the tactile sensitivity, since the actuation effort and the travel of each button may be modified by changing the forming time of the blister.

The invention will be better understood with the aid of the following description, with reference to the appended schematic drawing representing several embodiments of this lever.

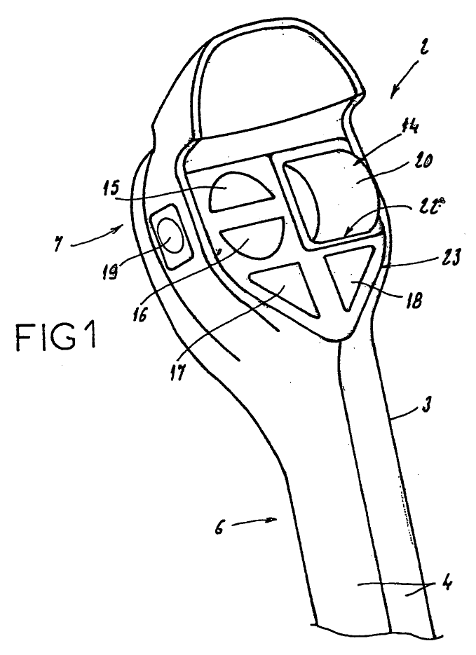

FIG. 1 is a view in perspective representing the upper portion of the lever, according to a first embodiment.

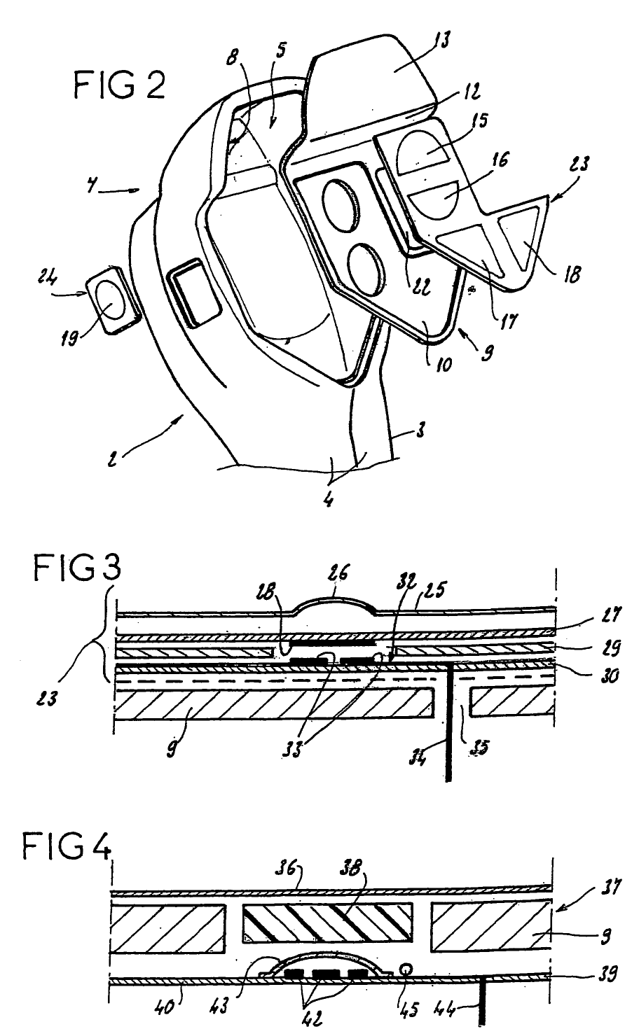

FIG. 2 is a partial view, in exploded perspective, of the lever of FIG. 1.

FIG. 3 is an exploded schematic view in section of a flexible keypad for the lever of FIG. 1.

FIG. 4 is an exploded schematic view in section of a flexible keypad for a lever according to a second embodiment.

FIGS. 1 to 3 represent a first embodiment of a lever 2. This lever 2 comprises a frame 3, made by the assembly of two symmetrical half-frames 4 delimiting an internal cavity 5. The bottom portion of the frame, not shown, is intended to be connected to a structure in a fixed or articulated manner. The central portion 6 of the frame is designed to be handled by an operator. The upper portion 7 of the frame 3 comprises an opening 8 communicating with the internal cavity 5, this opening 8 being intended to receive a support 9 in the form of a plate. In the embodiment shown, the support comprises three substantially flat portions 10, 12, 13, the first flat portion 10 of greater size than the two other portions 12, 13 being intended to house control buttons 14, 15, 16, 17, 18. A final control button 19 is housed on the side wall of the upper portion of the frame.

The control buttons comprise:
a cursor 14 making it possible to achieve a progressive control, this cursor consisting in known manner of a cylinder 20 mounted pivotingly about the median axis of an orifice 22 made in the support 9,
four buttons 15, 16, 17, 18 of the “on/off” type made in a first flexible keypad 23, attached to the support 9,
a fifth button 19 of the “on/off” type made in a second flexible keypad 24.

The flexible keypad 23 consists of several layers superposed in the following manner between the surface of the keypad 23 and the support 9:
a first layer consisting of a plastic surface film 25, supporting a serigraph, not shown, on its inner face thus rendering the graphic representation of the keypad undamageable, the film being heat-formed to obtain a blister 26 in the zones of electrical contact where it is desired to locate the control buttons 15, 16, 17, 18,
a second layer 27 made of polyester comprising on its inner face a serigraph made with a silver conducting ink in the zones of electrical contact in order to form a portion of upper conducting track 28,
a third insulating layer 29 forming a spacer and comprising openings in the zones of electrical contact, and
a fourth layer 30 made of polyester comprising on its outer face a serigraph made with a silver conducting ink so as to form an interrupted lower conducting track 32 between two contact portions 33.

The four layers 25, 27, 29, 30 forming the flexible keypad 23 are bonded to one another outside the zones of electrical contact. The flexible keypad 23 is bonded to the support 9. The bonding seals the assembly consisting of the flexible keypad 23, the support 9 and the frame 3.

The third insulating layer 29 separates the conducting tracks 28 and 32 when there is no pressure on the blister 26. When the operator's finger presses on the blister 26, the second layer 27 deforms placing the upper track 28 and lower track 32 in contact, the portion of conducting track 28 closing the electric circuit comprising the lower conducting track 32 and previously interrupted between the two contact portions 33.

The electric signal due to this electrical contact is sent to a control device, not shown, by means of a flat jumper 34 consisting of a pair of conducting wires connected to the ends of the lower conducting track 32, these conducting wires passing through an opening 35 of the support 9 communicating with the internal cavity 5 of the lever 2.

The second flexible keypad 24 is made in a manner similar to that described for the keypad 23, this keypad however being bonded directly to the frame 3 and not to the support 9.

According to a variant, the blister 26 may take a different form and height. Specifically, by modifying the deformation time of the film to obtain this blister, it is possible to fix at a determined value the operating force necessary to depress the layer 25 in the zone of the blister 26 to obtain an electrical contact as described hereinabove.

The layouts of the upper conducting track 28 and lower conducting track 32 are independent outside the zones of electrical contact.

Thus, from one and the same layout of the lower conducting tracks 32, the number and location of the control buttons 15, 16, 17, 18 depend on the layout of the upper conducting tracks 28.

According to a second embodiment, represented in FIG. 4, the flexible keypad 23 is made in the following manner, starting from the outside of the lever, by:
a first layer 36 consisting of a surface plastic film, supporting a serigraph, not shown, on its inner face making it possible to provide an indicator graphic, this film being deformable or nondeformable,
a second layer 37 consisting, outside the zones of electrical contact, of the support 9 and, in the zones of electrical contact, of a portion of translucent elastomer membrane 38 housed in an opening made in the support 9,
a third layer 39 consisting of a printed circuit comprising a rigid board 40, conducting tracks 42 and a steel cup 43 bonded to the outer face of the board 40 in each zone of electrical contact, placed opposite a conducting track 42.

The rigid board 40 is bonded and screwed onto the inner face of the support 9.

The cup 43 is convex so as to prevent contact between the latter and the opposite conducting track 42, when there is no pressure from the operator's finger. When the operator's finger presses on the surface of the keypad 23 in a zone of electrical contact, the elastomer membrane 38 deforms placing the cup 43 and the track 42 of the printed circuit in contact, thus closing an electric circuit.

The electric signal due to this electrical contact is sent to a control device, not shown, via conducting wires 44 situated in the internal cavity 5 of the lever 2.

This printed circuit forming the layer 39 also comprises light-emitting diodes 45 which, via the translucent elastomer membrane 38, light up the first layer 36 thus backlighting the keypad 23. The shape of the backlit zone may be defined by the serigraph of the first layer 36 which may comprise opaque or translucent portions.

The invention is not limited to the embodiments described; on the contrary, it embraces all the variants. Thus, in particular, the backlighting defined in the second embodiment may be applied in the first embodiment by adding, for example, an additional layer formed by a printed circuit.

1. A control lever for a manipulator, intended in particular for heavy construction machines, comprising a frame delimiting a cavity, and at least one control button intended to be actuated by an operator, characterized in that at least one control button consists of at least one lower insulating layer and one upper insulating layer placed on top, a lower conducting element being attached to the lower layer and a second upper conducting element being situated opposite the first in the location of a control button, these two elements being separated in the absence of pressure from the operator's finger and being able to enter into contact when pressure is transmitted from the operator's finger to the upper layer, the upper layer deforming and transmitting this movement to the upper conducting element, the contact between the lower conducting element and upper conducting element closing an electric circuit generating an electric control signal.

2. The lever as claimed in claim 1, characterized in that the upper conducting element consists of a convex and deformable conducting cup attached to the lower layer.

3. The lever as claimed in claim 1, characterized in that the upper conducting element consists of a conducting track made of a screen-printed conducting ink on the lower face of the upper layer, an intermediate layer being placed between the upper layer and lower layer, this intermediate layer having an opening in the location of the control button and separating the upper conducting element and lower conducting element when there is no pressure on the button.

4. The lever as claimed in claim 1, characterized in that an outer layer is attached on top of the upper layer, this layer comprising a serigraph on its inner face.

5. The lever as claimed in claim 1, characterized in that the lower layer comprises at least one light source allowing the backlighting of at least one portion of a control button.

6. The lever as claimed claim 1, characterized in that several control buttons are made with the same lower layer and upper layer.

7. The lever as claimed in claim 6, characterized in that the number of control buttons made with the same lower layer and upper layer can be varied according to the shape of the upper conducting elements for one and the same shape of the lower conducting elements.

8. The lever as claimed in claim 1, characterized in that the layers forming the control buttons are attached by bonding, thus sealing the buttons.

9. A method of manufacturing a lever as claimed in claim 4, characterized in that the outer layer is deformed in order to form a blister in the location of a control button, this deformation being adjustable according to the operating force required to depress the button.
